(19) United States
(12) Patent Application Publication
(10) Pub. No.: US 2004/0060987 A1
(43) Pub. Date: Apr. 1, 2004

(54) Digital image analysis method for enhanced and optimized signals in fluorophore detection

(76) Inventor: Larry R. Green, Tacoma, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/425,222

(22) Filed: Apr. 29, 2003

Related U.S. Application Data
(60) Provisional application No. 60/378,501, filed on May 7, 2002.

(51) Int. Cl. G06K 19/06

(52) U.S. Cl. 235/491; 235/494

(57) ABSTRACT

The present invention concerns methods and apparatus for detecting and/or identifying analytes, using arrays of binding moieties. In preferred embodiments, the arrays are attached to glass slides. Fluorescent signals obtained from the slides are analyzed by a digital image subtraction method. In preferred embodiments, the glass slides are labeled using a binary code that may be used to identify the lot number and/or date of manufacture of the arrays.

### RELATED APPLICATIONS

The present application claims the benefit under 35 U.S.C. §119(e) of Provisional U.S. Patent Application Serial No. 60/378,501, filed May 7, 2002, the entire contents of which are incorporated herein by reference.

### BACKGROUND OF THE INVENTION

1. Field of the Invention

The present invention relates to the field of fluorescent detection. More particularly, the present invention concerns detection and/or identification of analytes, using enhanced and optimized methods of digital image analysis. Alternatively, the present invention concerns methods and compositions for fluorescent code identification of waveguides, chips, arrays and/or other items.

2. Description of Related Art

Fluorescent tags are of common use in detection technologies. Fluorescent tags, available from commercial sources such as Molecular Probes, Inc. (Eugene, Oreg.), have been attached to various detector molecules, such as proteins, antibodies, antibody fragments, nucleic acids, oligonucleotide probes or primers, nucleotides, aptamers, substrates, analogs, inhibitors, activators, binding moieties, etc. Binding of a tagged molecule to a target compound may be detected by the presence of an appropriate fluorescent signal. Alternatively, the target compound may be tagged and allowed to bind to a detector molecule.

In certain applications, detector molecules may be attached to a substrate in an array, for example with protein or nucleic acid chips that can detect the presence of a variety of different target compounds in a single sample. Such chips may, for example, simultaneously detect all gene products expressed in a particular cell line, tissue, organ or species. In some cases, the concentration of target compounds in a sample may be determined by measuring the amount of fluorescence associated with an individual spot on an array.

Precise quantitation of fluorescence may be complicated by a variety of factors. Certain compounds that may be present in samples or in components of the apparatus itself may exhibit fluorescence, contributing to an enhanced and variable background. The fluorescently tagged probe molecules may exhibit some degree of non-specific binding, also contributing to background fluorescence. Various fluorescence quenching phenomena, such as mass-dependent scattering, fluorescence resonance energy transfer and/or other quenching mechanisms, may act to decrease the intensity of the fluorescent signal. A need exists for improved methods of analysis to accurately quantify the amounts of specifically bound fluorescent molecules.

Fluorescent detectors may be designed for use with a variety of different arrays that are diagnostic for specific applications. For example, one array may screen for common bacterial pathogens. Another array may screen for parasitic organisms. A different array may screen for environmental contaminants or toxins. Each array may contain different detector molecules, each selective for a different target. Alternatively, multiple arrays may contain different detector molecules that bind to various parts of a single target compound or a related group of targets. Each type of array must be distinguishably labeled so that bound target compounds may be identified.

One method of labeling arrays and other objects involves applying an identifier, such as a bar code label. Traditional bar code systems rely on the differences in reflection of the reading light from the black (light-absorbing) bars and the white (light-reflecting) spaces of the bar code. A typical bar code reader scans a laser beam across the bar code, monitors the reflectance from the bars and spaces and decodes the signal. This requires a separate series of steps, analysis and/or apparatus in addition to that required for fluorescent detection of bound molecules. A need exists for methods of labeling arrays and other objects with labels that can be detected by the same methods as fluorescence detection of bound analytes.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 illustrates an exemplary embodiment of a labeled array in the form of a Manhattan AssayChip™. The Figure indicates the presence of an exemplary binary code label.

FIG. 2 illustrates the coordinates for an exemplary 2:1 spot array pattern.

FIG. 3 illustrates in more detail an exemplary binary code label.

FIG. 4 illustrates an example of mass-dependent scattering with a bound fluorophore-labeled molecule. Reactive probes affixed to a glass surface effect an optical signal by diffracting, scattering, and in other ways altering light in addition to the excitation emission signal of the fluorophore.

### DESCRIPTION OF ILLUSTRATIVE EMBODIMENTS

Definitions

Terms that are not otherwise defined herein are used in accordance with their plain and ordinary meaning.

As used herein, “a” or “an” may mean one or more than one of an item.

As used herein, “fluorescence” refers to the emission of light in response to exposure to radiation from an external source. “Fluorescent” refers to an object that exhibits fluorescence. Although the present invention is directed towards fluorescent labels, the skilled artisan will realize that other types of light emitting tags, such as phosphorescent, luminescent, chemiluminescent and/or electroluminescent tags may be used in the claimed methods and compositions within the scope of the present invention.

“Item” as used herein refers to an object to be labeled, for example with a binary code label. The invention is not limiting as to the type of object to be labeled, so long as the object is capable of being marked with a fluorescent label. Non-limiting examples of “items” include chips, arrays, glass slides, plastic slides, ceramic objects, silicon objects, metal objects and waveguides. The material of which the item is composed is not limiting. In preferred embodiments the item is not intrinsically fluorescent and is comprised of material that is transparent to excitatory and/or emitted light.

As used herein, the terms “analyte” and “target” mean any compound, molecule or aggregate of interest for detection. Non-limiting examples of targets include a nucleic acid, polynucleotide, oligonucleotide, protein, polypeptide, peptide, carbohydrate, polysaccharide, glycoprotein, lipid, hormone, growth factor, cytokine, receptor, antigen, allergen, antibody, substrate, metabolite, cofactor, inhibitor, drug, pharmaceutical, nutrient, toxin, poison, explosive, pesticide, chemical warfare agent, biowarfare agent, biohazardous agent, infectious agent, prion, radioisotope, vitamin, heterocyclic aromatic compound, carcinogen, mutagen, narcotic, amphetamine, barbiturate, hallucinogen, waste product, contaminant, heavy metal or any other molecule or atom, without limitation as to size. “Targets” are not limited to single molecules or atoms, but may also comprise complex aggregates, such as a virus, bacterium, Salmonella sp., Streptococcus, Legionella, E. coli, S. aureus, Pseudomonas aeruginosa, Aspergillus niger, Burkholderia cepacia, Candida albicans, Giardia, Cryptosporidium, Rickettsia, spore, mold, yeast, algae, amoebae, dinoflagellate, unicellular organism, pathogen or cell. In certain embodiments, cells exhibiting a particular characteristic or disease state, such as a cancer cell, may be targets. Virtually any chemical or biological compound, molecule or aggregate could be a target. “Target compound” as used herein is synonymous with “target.”

As used herein, “detector molecule” and “binding moiety” refer to a molecule or aggregate that has binding affinity for one or more targets. Within the scope of the present invention virtually any molecule or aggregate that has a binding affinity for some target of interest may be a “binding moiety.” In preferred embodiments, the “binding moiety” is an antibody. In certain embodiments, the binding moiety is specific for binding to a single target, although in other embodiments the binding moiety may bind to multiple targets that exhibit similar structures or binding domains.

“Binding” refers to an interaction between a target and a binding moiety, resulting in a sufficiently stable complex so as to permit detection of the target:binding moiety complex. In certain embodiments, binding may also refer to an interaction between a second molecule and a target. For example, in a sandwich ELISA type of detection assay, the binding moiety is an antibody with affinity for a target. After binding of target to binding moiety, a second molecule, typically a tagged antibody with an affinity for a different epitope of the target, is added and the tertiary complex of first antibody:target:second tagged antibody is detected. In alternative embodiments, the first binding moiety may have affinity for a target while the second binding moiety has affinity for the first binding moiety. Although detection may involve the use of a second binding moiety with affinity for a target, in alternative embodiments the binary complex of binding moiety with target may be directly detected. The skilled artisan will be familiar with a variety of techniques by which a target:binding moiety complex may be detected, any of which may be utilized within the scope of the present invention.

The terms “detection” and “detecting” are used herein to refer to an assay or procedure that is indicative of the presence of one or more specific targets in a sample, or that predicts a disease state or a medical or environmental condition associated with the presence of one or more specific targets in a sample. It will be appreciated by those of skill in the art that all assays exhibit a certain level of false positives and false negatives. Even where a positive result in an assay is not invariably associated with the presence of a target, the result is of use as it indicates the need for more careful monitoring of an individual, a population, or an environmental site. An assay is diagnostic of a disease state or a medical or environmental condition when the assay results show a statistically significant association or correlation with the ultimate manifestation of the disease or condition.

Labeled Chips

In certain embodiments, analytes may be detected and/or identified using arrays of binding moieties attached to a surface, such as a chip. A non-limiting example of such a chip, the Manhattan AssayChip™, is disclosed below. The skilled artisan will realize that the claimed subject matter is not limited to the disclosed exemplary embodiment, but rather encompasses any known array, chip, slide or other item.

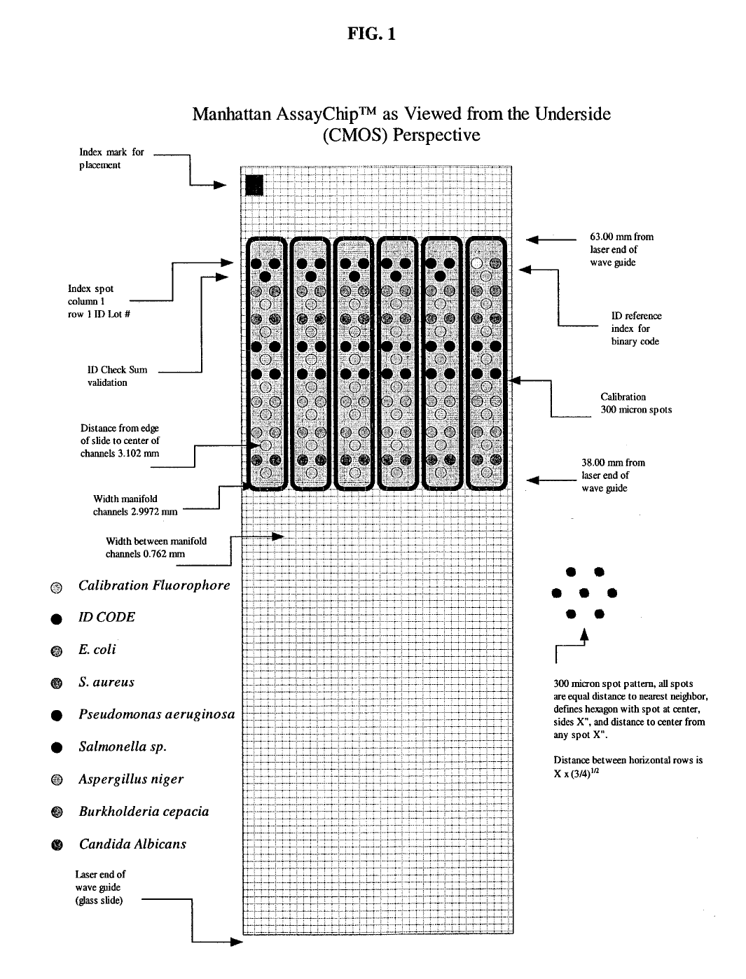

The exemplary AssayChip™ (FIG. 1) is a glass slide upon which antibodies, calibration spots, index spots and a binary label are deposited. The antibodies allow for the capturing of pathogens and/or other analytes and their subsequent detection using fluorescent-labeled reagents. In preferred embodiments of the invention, a fluidic cube is used for mixing fluids and activating spots so they can be visualized. A non-limiting example of a fluidic cube and detection unit that may be used is disclosed in U.S. patent application Ser. No. 09/974,089, filed Oct. 10, 2001, the entire text of which is incorporated herein by reference.

In certain embodiments, a laser is directed to one end of the AssayChip™ that protrudes from a disposable fluidic cube (see, e.g., U.S. patent application Ser. No. 09/974,089). The slide acts as a waveguide, dispersing energy across the AssayChip™ to the target area on the glass slide that is used to capture and image target analytes. The AssayChip™ must properly fit the fluidic cube, the channels in the cube for fluid flow and the target area for imaging. Thus, in preferred embodiments the dimensions of the various spots bound to the slide are as indicated in Table 1. Because the channel widths and interchannel spacing on the fluidic cube may be fixed, in certain embodiments the target area and number of possible spots that can be detected on the AssayChip™ may be subject to constraints imposed by the dimensions of the fluidic cube

TABLE 1
Preferred Physical Parameters of the AssayChip ™

| Parameter | Acronym | Value | | | |
|---|---|---|---|---|---|
| Number of channels | C | 6 | | | |
| AssayChip ™ width | w | 25.000 | mm | 25000 | microns |
| AssayChip ™ length | 1 | 75.000 | mm | 75000 | microns |
| AssayChip ™ thick- | t | 1.000 | mm | 1000 | microns |
| ness | | | | | |
| Channel length | CL | 25 | mm | 25000 | microns |
| Channel width | CW | 2.9972 | mm | 2997 | microns |
| Center to center of | CCC | 3.7592 | mm | 3759 | microns |
| channel | | | | | |
| Edge to center of first | EC | 3.102 | mm | 3102 | microns |
| channel | | | | | |
| Interchannel width | ICW | 0.762 | mm | 762 | microns |
| Proximal boundary tar- | PB | 38.00 | mm | 38000 | microns |
| get area | | | | | |
| Distal boundary target | DB | 63.00 | mm | 63000 | microns |
| area | | | | | |
| Index mark (coord- | IM | 24,74 | mm | | |
| inates) | | | | | |
| AssayChip ID code | ACID | 0.300 | mm | 300 | microns |
| spot diameter | | | | | |
| Target area | 25 × 25 | | mm² | 25,000 × | micron² |
| | | | | 25,000 | |
| Edge width | EW | 1.603 | mm | 1603 | microns |
| 2:1 Array Chip | | | | | |
| Interspot distance (2:1 | ISD | 1.880 | mm | 1880 | microns |
| array) | | | | | |
| Distance between | HRD | 1.628 | mm | 1628 | microns |
| horizontal rows | | | | | |
| Spot size (diameter) | SS | 0.300 | mm | 300 | microns |

| | |
|---|---|
| Rows of spots per channel | 15.4 |
| Spots per channel on a row | 1.5 |
| Total spots per channel | 23 |
| Total spots per AssayChip ™ | 138 |

In various embodiments, the fluidic cube contains six fluid filled channels that may be used to apply samples and reagents to the AssayChip™, corresponding to six lanes of calibration and binding moiety spots on the AssayChip™. The channels on the fluidic cube form the manifold for fluid flow across the AssayChip™. Prior to use, antibodies or other binding moieties, calibration spots, index mark spots, binary code spots and/or any other spots are printed on the AssayChips™, for example as disclosed in U.S. patent application Ser. No. 10/035,367, filed Dec. 28, 2001, incorporated herein by reference in its entirety. The printed surface of the AssayChip™ is affixed to the fluidic cube so that antibodies or other binding moieties deposited on the surface are aligned with the fluidic cube manifold channels. The channels are separated from each other by a gasket that prevents fluid leaks. Each AssayChip™ has an index mark in one corner that is fitted to the fluidic cube to properly align the AssayChip™ with the cube. Clips on the fluidic cube hold the slide securely in place and compress it against the gasket.

In certain embodiments, glass slides used to print AssayChips™ are microscope glass slides without obvious defects, measuring precisely 25 mm in width (w), 75 mm in length (l), and 1 mm in thickness (t). The area of the slide used for imaging is the target area. This area begins at 38.00 mm from the proximal end of the slide, where laser excitatory light is directed, and ends at 63.00 mm distally. The target area includes the entire width of the slide (25 mm). The adjustment and focus on a stage aligning the slide with a detection unit centers the entire 25×25 mm target on the detection unit, such as a CMOS chip imager.

In preferred embodiments, various dimensions of the fluidic cube channels and corresponding regions of the AssayChip™ are as disclosed in Table 1. The visualized channel length imaged in the target area is 25 mm, with a channel width of 2.9972 mm. There are 6 channels per fluidic cube, separated by an interchannel width of 0.762 mm. The distance from the edge of the slide to the center of the first or sixth channel is 3.102 mm. The distance from the center of one channel to the center of an adjacent channel is 3.7592 mm. The distance from the laser end of the slide to the edge of the target area nearest the laser measures 38.00 mm. The distance from the laser end of the slide to the furthest part of the target area is 63.00 mm. The edge width is the shortest distance from the edge of the slide to the edge of the first or sixth channel. For a 25.00 mm wide slide, the edge width is 1.603 mm.

In some embodiments of the invention, images on the surface of the slide may be transferred optically to the surface of a detection unit, such as a CMOS imager, located in a different plane. In such embodiments, a cone or magnifying effect of light is observed where spots appear on the imager more than twice their actual size on the surface of the glass. In order to preserve a sufficiently large space between spots to allow for this magnification, the spacing and size of spots and the number of spots in a channel are constrained. In preferred embodiments, spots are less than or equal to 300 microns in diameter to facilitate printing and visualization. In other preferred embodiments, calibration spots are placed within the channel areas. This prevents damage to the calibration spots due to possible movement of the gasket located in the interchannel areas.

In certain embodiments, the distance between spots on an array may be optimized so that the software used in capturing an image never detects two spots in the same field. In preferred embodiments, the effective (visualized) distance between any two spots is at least twice the diameter of the spot. In various embodiments, both the background where spots do not exist and illuminated spots are used in calculating luminosity. Multiple frames may be taken to evaluate an image.

Array Patterns

In various embodiments, the slide is centered on the fluidic cube with three channels to either side of a line bisecting the glass slide. Various patterns of binding moiety and calibration spots on an array are possible. The simplest pattern is a 1:1 pattern where the spots are aligned in mid channel in a single file along the channel. The next most complex pattern is a 2:1 pattern. In the first row, 2 spots straddle the center line of the channel, while in the next row a spot is precisely on the mid line of the channel. The pattern repeats itself, alternating 1 or 2 spots per channel row until the end of the channel is reached. Because the spacing between spots is equidistant, the distance between rows is the interspot distance (ISD) multiplied by the square root of ¾.

The exemplary AssayChip™ shown in FIG. 1 has 18 columns and 16 rows of spots. Column numbers increase sequentially from the left side of FIG. I to the right side, while row numbers increase sequentially from the top of FIG. 1 towards the bottom. In the 2:1 pattern of spots shown in FIG. 1, the second, fifth, eighth, eleventh, fourteenth and seventeenth columns are located in the centers of the fluid cube channels, with a top spot that is in a lower position than the top spots of the adjacent columns. Similarly, rows 2, 4, 6, 8, 10, 12, 14 and 16 comprise single spots located in the centers of the fluid cube channels.

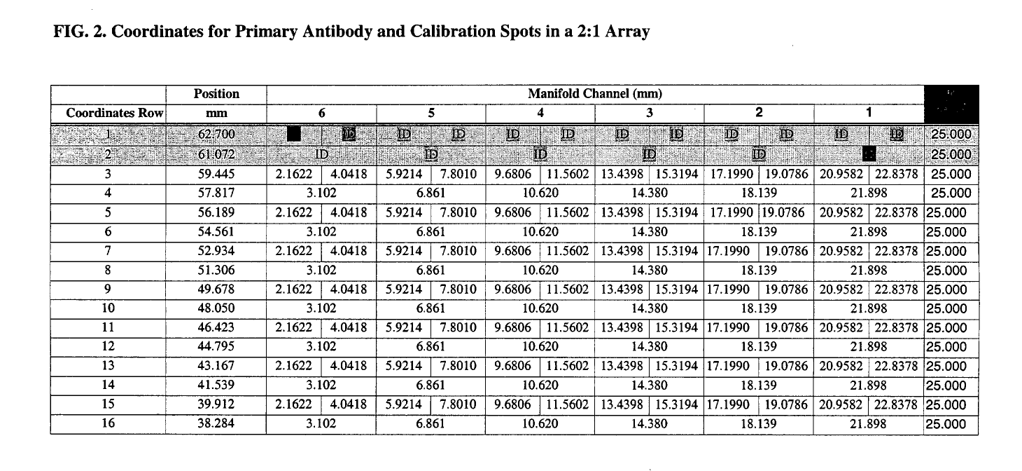

The number of spots per channel is determined by the ISD. In preferred embodiments, the channel width is 2997 microns, spot diameter is 300 micron and the ISD is 1880 microns. This results in an AssayChip™ with 16 rows and 24 spots per channel in a 2:1 array pattern. The coordinates for an exemplary spot deposition pattern in a 2:1 array are provided in FIG. 2. In this embodiment, the calibration spots are the single spots located in the centers of the channels (rows 4, 6, 8, 10, 12, 14 and 16). The coordinates for binding moiety (antibody) spots are shown in rows 3, 5, 7, 9, 11, 13 and 15. The coordinates are in millimeters with the proximal (laser) end of the slide nearest row 16 and the distal end nearest row 1. Rows begin at 0 mm at the left edge of the slide to 25.00 mm at the right edge of the slide. The proximal (laser end) of the slide is 0 mm and the distal end of the slide is 75.00 mm. Positions for the reference index spots are respectively, for binary 0 (coordinates 62.700, 4.0418), binary 1 (coordinates 62.700, 2.1622), and the check sum reference spot in row 2, column 2 (coordinates 61.072, 21.898). The row 2, column 17 spot at coordinate 61.072, 3.102 is a standard calibration spot.

Binary Code

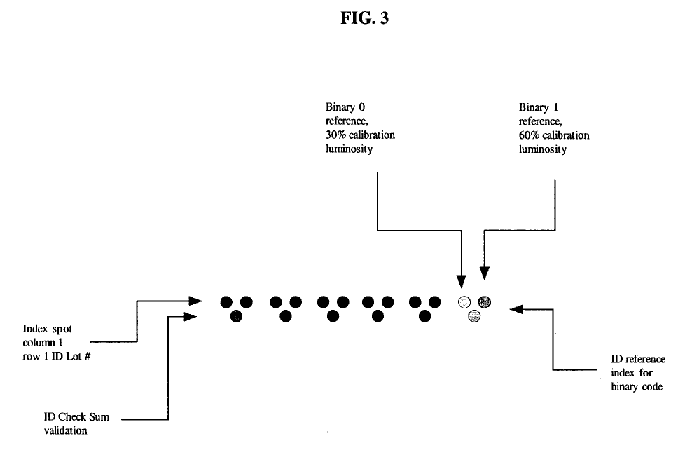

An entire set of slides may be produced in a single lot. Slides from different lots may be distinguished by a coded label attached to the slide. In preferred embodiments, the coded label comprises a binary code of fluorescent spots. A non-limiting example of such a binary code is disclosed in FIG. 3. The code identifies the slide lot number and may be used to determine the antibodies or other binding moities attached to each spot on each AssayChip™. Although the preferred embodiment is a binary code, the skilled artisan will realize that other types of codes, such as tertiary or even quaternary codes could be used within the scope of the present invention.

The binary code system used to identify a particular lot number is located in the first two rows of the AssayChip™ shown in FIG. 1. There are 3 reference spots in the first two rows, located in the channel on the far right side of FIG. 1. Those 3 reference spots are used to determine whether the other spots in the adjacent rows and channel are binary 1 or binary 0 spots. A fourth reference spot located at the coordinates for row 2 column 2 is a quality assurance check sum on the intended code for the lot number assigned. The other 14 spots in the first two rows are either empty or coated with fluorophore at the same concentration and volume as is used for calibration spots. Those 14 spots are determined to have either 0 or 1 binary code values by comparison to the binary reference marks on the right side of FIG. 1.

The binary code spot pattern from FIG. 1 is reproduced in FIG. 3. FIG. 3 shows in more detail the locations of the quality assurance check sum spot, the binary 0 reference spot, the binary 1 reference spot and the ID reference index spot for the binary code.

Binary 0 and Binary 1 Reference Spots

The binary 0 reference spot is a 300 micron diameter spot with 10% of the amount of fluorophore used in a standard calibration spot. The binary 1 reference spot is a 300 micron spot with 30% of the amount of fluorophore used in a standard calibration spot. Use of these amounts of fluorophore result in luminescent signals that are approximately 30% and 60% of the intensity of the standard calibration spot. If any of the 14 spots (code spots) used to set the binary code are measured with a luminosity of lower intensity than the binary 0 reference spot, they are assigned a value of 0. A code spot with a measured luminosity greater than both the binary 0 reference spot and the binary 1 reference is assigned the value of 1. A code spot with a measured luminosity greater than the binary 0 reference spot, but less than the binary 1 reference spot, registers as a defective AssayChip™ and is reported to the operator as an error.

The 14 code spots provide a fourteen digit binary code identifier number that may be used to identify the lot number. In certain preferred embodiments, only one lot is prepared per day, although it is envisioned that multiple lots may be prepared per day. Where one lot is prepared per day, the lot number identifier may be equivalent to a date of manufacture and information on the AssayChip™ content may be stored by manufacture date. In other embodiments, AssayChip™ content data may be stored by lot number, using the binary code identifier. In alternative embodiments, the binary code identifier may be determined and code spots printed using a software program, for example, a custom designed software program that automatically determines the binary code pattern and reference spot intensities. A program may also be used to print the check sum validation spot. An exemplary set of spot luminosities determined by a custom sofware program is provided in Table 2. The first row contains spots 1 to 12 indexed from left to right. The second row contains spots 13 to 18 indexed from left to right (see FIG. 3)

TABLE 2
Binary Code for Date Identification

Base Date: 1/1/2002
Code Date: 2/22/2002
Spot Values:
First Row:
Spot# 1: 0% luminosity
Spot# 2: 0% luminosity
Spot# 3: 100% luminosity
Spot# 4: 0% luminosity
Spot# 5: 100% luminosity
Spot# 6: 100% luminosity
Spot# 7: 0% luminosity
Spot# 8: 0% luminosity
Spot# 9: 0% luminosity
Spot#10: 0% luminosity
Spot#11: 30% luminosity (maximal 0)
Spot#12: 60% luminosity (minimal 1)
Second Row:
Spot#13: 100% luminosity (checksum bit)
Spot#14: 0% luminosity
Spot#15: 0% luminosity
Spot#16: 0% luminosity
Spot#17: 0% luminosity
Spot#18: 100% luminosity (binary code present flag)
Base Date: 1/1/2002
Code Date: 5/6/2002
Spot Values:
First Row:
Spot# 1: 100% luminosity
Spot# 2: 0% luminosity
Spot# 3: 100% luminosity
Spot# 4: 100% luminosity
Spot# 5: 100% luminosity
Spot# 6: 100% luminosity
Spot# 7: 100% luminosity
Spot# 8: 0% luminosity
Spot# 9: 0% luminosity
Spot#10: 0% luminosity
Spot#11: 30% luminosity (maximal 0)
Spot#12: 60% luminosity (minimal 1)
Second Row:
Spot#13: 0% luminosity (checksum bit)
Spot#14: 0% luminosity
Spot#15: 0% luminosity
Spot#16: 0% luminosity
Spot#17: 0% luminosity
Spot#18: 100% luminosity (binary code present flag)
Base Date: 1/1/2002
Code Date: 7/1/2002
Spot Values:
First Row:
Spot# 1: 100% luminosity
Spot# 2: 0% luminosity
Spot# 3: 100% luminosity
Spot# 4: 0% luminosity
Spot# 5: 100% luminosity
Spot# 6: 100% luminosity
Spot# 7: 0% luminosity
Spot# 8: 100% luminosity
Spot# 9: 0% luminosity
Spot#10: 0% luminosity
Spot#11: 30% luminosity (maximal 0)
Spot#12: 60% luminosity (minimal 1)
Second Row:
Spot#13: 100% luminosity (checksum bit)
Spot#14: 0% luminosity
Spot#15: 0% luminosity
Spot#16: 0% luminosity
Spot#17: 0% luminosity
Spot#18: 100% luminosity (binary code present flag)
Base Date: 1/1/2002
Code Date: 8/12/2002
Spot Values:
First Row:
Spot# 1: 100% luminosity
Spot# 2: 100% luminosity
Spot# 3: 100% luminosity
Spot# 4: 100% luminosity
Spot# 5: 100% luminosity
Spot# 6: 0% luminosity
Spot# 7: 100% luminosity
Spot# 8: 100% luminosity
Spot# 9: 0% luminosity
Spot#10: 0% luminosity
Spot#11: 30% luminosity (maximal 0)
Spot#12: 60% luminosity (minimal 1)
Second Row:
Spot#13: 100% luminosity (checksum bit)
Spot#14: 0% luminosity
Spot#15: 0% luminosity
Spot#16: 0% luminosity
Spot#17: 0% luminosity
Spot#18: 100% luminosity (binary code present flag)
Base Date: 1/1/2002
Code Date: 10/9/2002
Spot Values:
First Row:
Spot# 1: 100% luminosity
Spot# 2: 0% luminosity
Spot# 3: 0% luminosity
Spot# 4: 100% luminosity
Spot# 5: 100% luminosity
Spot# 6: 0% luminosity
Spot# 7: 0% luminosity
Spot# 8: 0% luminosity
Spot# 9: 100% luminosity
Spot#10: 0% luminosity
Spot#11: 30% luminosity (maximal 0)
Spot#12: 60% luminosity (minimal 1)
Second Row:
Spot#13: 0% luminosity (checksum bit)
Spot#14: 0% luminosity
Spot#15: 0% luminosity
Spot#16: 0% luminosity
Spot#17: 0% luminosity
Spot#18: 100% luminosity (binary code present flag)
Base Date: 1/1/2002
Code Date: 12/24/2002
Spot Values:
First Row:
Spot# 1: 100% luminosity
Spot# 2: 0% luminosity
Spot# 3: 100% luminosity
Spot# 4: 0% luminosity
Spot# 5: 0% luminosity
Spot# 6: 100% luminosity
Spot# 7: 100% luminosity
Spot# 8: 0% luminosity
Spot# 9: 100% luminosity
Spot#10: 0% luminosity
Spot#11: 30% luminosity (maximal 0)
Spot#12: 60% luminosity (minimal 1)
Second Row:
Spot#13: 100% luminosity (checksum bit)
Spot#14: 0% luminosity
Spot#15: 0% luminosity
Spot#16: 0% luminosity
Spot#17: 0% luminosity
Spot#18: 100% luminosity (binary code present flag)

Check Sum Validation Spot

A check sum validation spot, located at row 2 column 2, will be either completely filled or left empty as a validation of the binary code on the AssayChip™. If the sum of the value 1's in the binary code assigned for a particular lot number is an even number, then the value 0 (empty spot) will be assigned for the check sum validation spot. If the sum of the value 1's in the binary code assigned for a particular lot number is an odd number, then the value 1 (filled spot) will be assigned for the check sum validation spot. The check sum validation spot when read against the binary code reference spots is either 0 or 1. If the value read fails to match the assigned value for a particular production date, the AssayChip™ may be assumed to have been incorrectly printed.

The skilled artisan will realize that although the exemplary code labeling system is binary, it could easily be set up as, for example, a tertiary system to increase the number of distinguishable code labels available. For example, a tertiary system could be derived with three alternative values of luminosity for code spots: 1) less than the binary 0 reference spot; 2) in between the binary 0 and binary 1 reference spots; and 3) greater than the binary 1 reference spot. All such variations on the disclosed code labeling scheme are contemplated within the scope of the present invention.

Fluorescent Tags

In preferred embodiments, target compounds or binding moieties may be attached to a fluorescent tag. Attachment may be either covalent or non-covalent. Preferably, the same fluorescent tag is incorporated into a label, such as a binary code label, as well as calibration spots. The fluorescent tag emits electromagnetic radiation, preferably visible light. The invention is not limiting as to the fluorescent tag that is used, but may encompass any known fluorescent tag.

Fluorescent tags may be obtained from commercial sources, such as Molecular Probes, Inc. (Eugene, Oreg.). Non-limiting examples of fluorescent tags of use in the described methods include the Alexa 350, Alexa 430, AMCA, BODIPY 630/650, BODIPY 650/665, BODIPY-FL, BODIPY-R6G, BODIPY-TMR, BODIPY-TRX, Cascade Blue, Cy2, Cy3, 4-(4′-dimethylaminophenylazo) benzoic acid (DABCYL), Cy5,6-FAM, 5-(2′-aminoethyl)aminonaphthalene-1-sulfonic acid (EDANS) Fluorescein, 5-carboxyfluorescein (FAM), HEX, 2′7′-dimethoxy-4′5′-dichloro-6-carboxyfluorescein (JOE), 6-JOE, Oregon Green 488, Oregon Green 500, Oregon Green 514, Pacific Blue, 6-carboxyrhodamine (R6G), REG, Rhodamine Green, Rhodamine Red, ROX, TAMRA, TET, Tetramethylrhodamine, and Texas Red.

In certain embodiments, it is contemplated that fluorescently tagged beads, such as FluoSpheres (Molecular Probes, Eugene, Oreg.) may be used to fluorescently tag targets. For example, a second antibody with affinity for the target may be covalently or non-covalently attached to a FluoSphere and used in a sandwich ELISA type assay. FluoSpheres have the advantage of providing a more intense fluorescent tag, allowing detection of targets at increased sensitivity. It is contemplated that known quantities of FluoSpheres could also be used to create calibration spots on an array or other object. In certain embodiments, Alexa Fluor 647 is preferred as a fluorescent tag. The fluorophore provides a brighter evanescent wave than other available fluorophores and is stable over a pH range from 4 to 10.

In other embodiments of the invention, a biotin-streptavidin system may be used to attach fluorophores to analytes, binding moieties and/or calibration spots. For example, a secondary antibody with affinity for an analyte of interest could be covalently labeled with biotin, and an avidin or streptavidin conjugated fluorophore could be added. Similarly, calibration spots could be attached to, for example, biotin-labeled bovine serum albumin (BSA). Thus, the streptavidin conjugated fluorophore could bind simultaneously to the biotin-labeled antibody and biotin-labeled BSA. This would provide a further internal control for the calibration process, ensuring that any decreased efficiency in biotin-streptavidin binding is accounted for. In preferred embodiments, biotin-labeled BSA could be attached to the AssayChip™ using the same chemistries and at the same time as antibodies or other binding moieties are attached to the chip.

Although in preferred embodiments disclosed above the calibration spots, binary code spots, reference spots and analyte:binding moiety spots are fluorescently labeled, it is contemplated within the scope of the invention that other types of labels may be used. In certain preferred embodiments, the index mark contains a visible pigment, such as a latex paint, to facilitate proper alignment of the AssayChip™ and any biosensor, fluidic cube and/or detection unit to be used with the AssayChip™. In certain alternative embodiments of the invention, the same type of visible pigment could be used for the code spots. For example, the binary zero reference spot could potentially be a 50 μm pigment spot, the binary 1 reference spot a 100 μm pigment spot, and the “1's” in the check sum and code spots could be 300 μm pigment spots. Many other alternative methods for marking the binary code and reference spots are known in the art and any such method may be used within the scope of the present invention.

Cross-Linking Reagents

In certain embodiments, the binding moieties or targets of interest may be attached to a surface by covalent or non-covalent interaction. In other embodiments, fluorescent tags may be attached to binding moieties or to targets of interest. One means for promoting such attachments involves the use of chemical or photo-activated cross-linking reagents. Such reagents are well known in the art and it is contemplated that any such reagent could be of use in the practice of the claimed invention.

Homobifunctional reagents that carry two identical functional groups are highly efficient in inducing cross-linking. Heterobifunctional reagents contain two different functional groups. By taking advantage of the differential reactivities of the two different functional groups, cross-linking can be controlled both selectively and sequentially. The bifunctional cross-linking reagents can be divided according to the specificity of their functional groups, e.g., amino, sulfhydryl, guanidino, indole, carboxyl specific groups. Of these, reagents directed to free amino groups have become especially popular because of their commercial availability, ease of synthesis and the mild reaction conditions under which they can be applied. Many heterobifunctional cross-linking reagents contain a primary amine-reactive group and a thiol-reactive group.

Exemplary methods for cross-linking molecules are disclosed in U.S. Pat. No. 5,603,872 and U.S. Pat. No. 5,401,511, incorporated herein by reference. Various binding moieties can be covalently bound to surfaces through the cross-linking of amine residues. Amine residues may be introduced onto a surface through the use of aminosilane, for example. Coating with aminosilane provides an active functional residue, a primary amine, on the surface for cross-linking purposes. In another exemplary embodiment, the surface may be coated with streptavidin or avidin with the subsequent attachment of a biotinylated molecule, such as an antibody or target. In preferred embodiments, binding moieties are bound covalently to discrete sites on the surfaces. To form covalent conjugates of binding moieties and surfaces, various cross-linking reagents have been used, including glutaraldehyde (GAD), bifunctional oxirane (OXR), ethylene glycol diglycidyl ether (EGDE), and a water soluble carbodiimide, preferably 1-ethyl-3-(3-dimethylaminopropyl) carbodiimide (EDC).

In another non-limiting example, heterobifunctional cross-linking reagents and methods of using the cross-linking reagents are disclosed in U.S. patent Ser. No. 5,889,155, incorporated herein by reference. The cross-linking reagents combine, for example, a nucleophilic hydrazide residue with an electrophilic maleimide residue, allowing coupling in one example, of aldehydes to free thiols. The cross-linking reagent used can be designed to cross-link various functional groups.

Detection Unit

In certain embodiments, the fluorescence intensities of code label, calibration and binding moiety spots may be detected by a detection unit. The detection unit may comprise one or more detectors, such as a spectrometer, monochromator, CCD device, CCD camera, photomultiplier tube, photodiode, avalanche photodiode or any other device known in the art that can detect an optical signal. An optical signal may comprise any form of electromagnetic radiation, emission, or absorption, although in preferred embodiments the optical signal comprises visible light.

In an exemplary embodiment, excitatory light is provided to one edge of the AssayChip™ by an excitatory light source, such as a diode laser. A non-limiting example of an excitatory light source is a 15 mW LaserMax model LAX 200-635-15 diode laser (LaserMax Inc., Rochester, N.Y.), powered by a wall transformer input (AC 120V 60 Hz 8W) with a direct current output of 5V and 350 ma. Laser input into the AssayChip™ may be accomplished using a line generator that spreads the laser beam into a 1 mm horizontal line. The laser light preferably strikes the edge of the AssayChip™ at an angle of about 30 degrees. The laser may be turned on and off using controlling software connected via a control interface. Optical signals may be detected through the detector aperture using a detector. In certain embodiments, one or more optical components may be interposed between the AssayChip™ and detector, such as a lens array to focus optical signals from each spot, a bandpass filter and a longpass filter to prevent excitatory light from reaching the detector and to decrease background noise from the AssayChip™. A non-limiting example of a detector comprises a CMOS camera sensor or equivalent unit, such as a PixeLink model AL633 CMOS imager (Vitana Corp., Ottawa, Canada).

In certain embodiments, a CMOS camera with a scan time of about 350 msec may be used to detect and quantify optical signals from the AssayChip™. Because there is an approximately 100 msec delay between the time that the detector begins scanning the front edge of the AssayChip™ and the time that it begins scanning the back edge, binding moiety spots at the front of the waveguide surface may be overexposed compared to spots at the back, rendering accurate quantitation difficult. To eliminate this effect, it may be preferred in some embodiments to delay activation of the laser excitation beam for 100 msec after initiation of detector scanning. In certain embodiments, multiple exposures of the same AssayChip™ surface may be preferred. Background optical signals from areas of the AssayChip™ adjacent to the binding moiety or calibration spots may be subtracted from the signals obtained from the binding moiety or calibration spots.

Digital Image Analysis

Fluorophores may be used to detect either the presence or absence of analyte binding to an AssayChip™ by measuring the intensity of emitted light (evanescent wave) produced when the fluorophore is excited with a laser or other light source. The laser may be used to excite the fluorophore at its absorption peak and the detector may be tuned to read the emission signal at a longer wavelength, characteristic of the emission for that particular fluorophore. The shift in wavelength between absorption and emission is referred to as the Stokes shift. Ideally, fluorophores with a large Stokes shift are used so that emission and absorption curves are well separated.

Because the curves for absorption and emission may be very near each other, accurate reading of the emission signal is often complicated. If the separation between the peak emission and peak absorption curves is small, it may be difficult to separate the light from an emission spectrum from that of the excitation signal. Lasers with a narrow band at the absorption peak are frequently used with filters to cut out all light up to a point just below the emission spectral curve. By selecting an appropriate long pass filter, band pass filter, or combination of long pass and band pass filters, the emission signal can be observed in a narrow window, eliminating much of the interference from the excitatory light source. Nevertheless, light from the excitatory light source should not directly strike the detector. This is generally avoided by alignment so that the emission signal can be read at a large angle to the incident excitation beam. However, other difficulties may complicate accurate measurement of fluorescent signals.

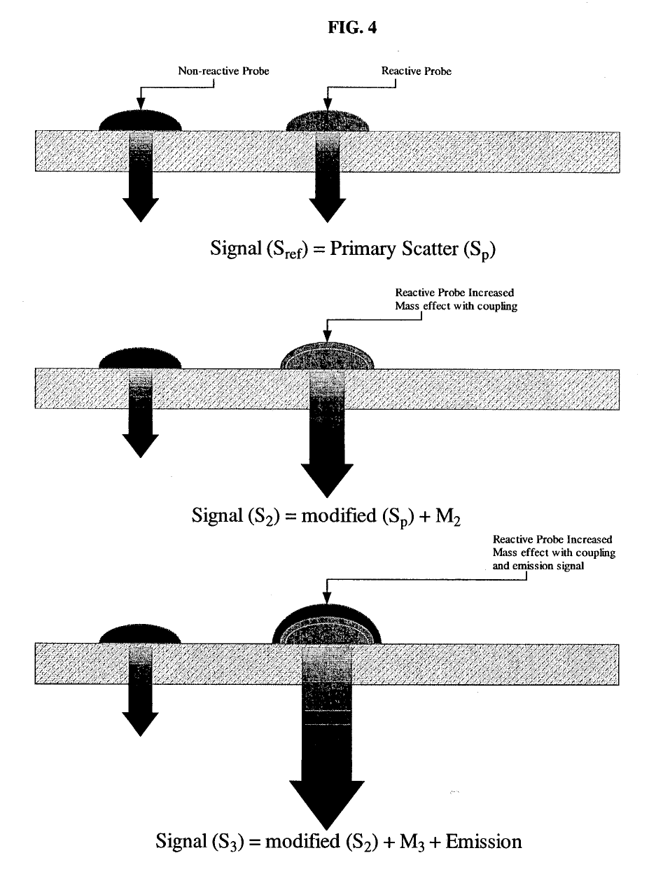

When a substance such as a binding moiety or target molecule is affixed to the surface of a glass slide, it acts as a mirror to reflect and scatter light in a variety of directions. The amount of surface covered and the mass or density of the material on the glass surface may greatly affect the amount of scattered light. The chemical composition of proteins, nucleic acids, oligonucleotides, polymers or other molecules attached to a glass surface may result in differential effects on light scattering that may vary depending on the precise nature of the attached molecule(s) (FIG. 4). To further complicate matters, the glass and/or any adhesive material coated on the glass surface may also fluoresce. A bioluminescent signal may be also observed with certain sample fluids. The glass may have irregularities on its surface that affect the signals that are detected. The excitatory and/or emitted light absorbed by the glass may vary from one spot to another. All of these potential problems make signal analysis very difficult.

Existing solutions to these problems are less than satisfactory. Filters may be useful in blocking part of the excitatory light from the light source used to excite a fluorophore. However, filters also cut out a significant portion of the evanescent (emitted light) signal. Most band pass filters cut out as much as 40 to 50% of the emitted light signal. Long pass filters may cut another 10% of the emitted light signal that might be detected if the filters were not present. Thus, in exchange for eliminating or reducing the light impinging on the detector from the excitatory light source, filters may substantially reduce the amount of light reaching the detector from fluorescence emission. This reduces the sensitivity and efficiency of analyte detection.

Such problems are further exacerbated with fluorophores that have a relatively small Stokes shift between absorption and emission peaks. With such fluorophores, it may be necessary to excite the fluorophore at a shorter wavelength than the peak absorption maximum because the emission and absorption curves overlap. The signal output emission intensity and sensitivity for detecting analytes is further reduced, making it difficult to detect analytes present in low concentration.

Evanescent Emission and Scattered Light:

Light scattering occurs by reflection, while light dispersion occurs by reflection and bending of the light beam (refraction). Depending on the detection system, fluorophore and the binding moiety array used, scattered and/or dispersed light may represent a large part of the light striking a detector. Evanescent signals are generally weak and scatter may be intense. Scattered light is generally assumed to be removed by filters. However, filters may pass small amounts of scattered excitatory light. If the scattered light is high in intensity compared to the evanescent emitted light, the signal detected by the detector will be a combination from several sources, some of which have nothing to do with binding of analyte.

FIG. 4 illustrates a theoretical treatment of light scattering. Two spots are initially deposited on a glass surface. During a series of steps in an assay procedure, one of the spots remains totally non-reactive. The other spot reacts with reagents, sample, and other materials to which it is exposed. For example a pathogen binds to primary antibodies affixed to the glass surface of the reactive spot. Binding of pathogen to the primary antibody increases the mass bound to the glass surface and results in a larger surface area of the spot. Because of the increased mass and change in spot structure, scattering of light from the reactive spot is likely to be different from light scattering from the non-reactive spot, or from the reactive spot before binding of pathogen.

A sensitive photon detector could be used to detect this difference in scatter. The change in scattering signal is the difference between the reference signal (S_{ref}) and the signal with bound analyte (S₂) (FIG. 4). S₂ comprises two components, a modified primary scatter signal (Sₚ) plus a mass-dependent effect of the coupled pathogen (M₂). As indicated in FIG. 4, the amount of light scattering will change for the reactive spot but not the non-reactive spot signal:

Δ (non-reactive spot)=0

Δ (reactive spot)=Modified (Sₚ)+M₁−S_{ref}

If the mass effect is sufficiently large to produce a significant scatter effect, a bound fluorophore may not be required in order to detect analyte binding. For example, in DNA hybridization experiments, the mass of the oligonucleotide binding to a reactive spot is nearly doubled after hybridization. Such a large change in mass and in mass-dependent light scattering might be detected in the absence of bound fluorophore.

In the case of analyte detection by sandwich immunoassay with a biotinylated secondary antibody, a second mass effect occurs when the biotinylated antibody binds to the pathogen. A third mass effect may occur when an avidin-fluorophore conjugate couples with the biotin. The fluorophore may then be excited by the excitatory light source, producing emitted light. The final signal detected by the detector represents the sum of all light signals from the spot:

(S₃)=modified (S₂)+M₃+Emission

All of these changes in the optical properties of the spot may be used to detect analyte binding. In exemplary embodiments, an initial digital signal in the absence of analyte (S_{ref}) is obtained and subtracted from the final captured signal after fluorophore coupling and excitation (S₃). The difference for each reactive spot represents the accumulated and modified effects of light scattering plus the emission signal.

Δ (reactive spot)=Modified accumulated mass effects+Emission

To summarize, an AssayChip™ or other array of binding moieties is set up with calibration spots, binding moiety spots, binary code and reference spots, check sum validation spot and/or index mark. Using no filters, a digital image is obtained of each binding moiety spot on the chip. The chip is exposed to sample and processed for labeling with fluorescent probes. Using no filters, another digital image is obtained for each binding moiety spot. The fluorescence intensity of the first image is subtracted from the fluorescence intensity of the second image to obtain a corrected analyte dependent luminescence for each binding moiety spot. The absence of filters and the incorporation of data from mass-dependent scattering results in a very high sensitivity of the system compared to traditional analytical methods. Although the preferred embodiment discussed above relies upon subtraction of an initial digital image from a final digital image, it is envisioned that digital images may be obtained at a variety of stages of the procedure. For example, an image could be taken of the dry AssayChip™, of an AssayChip™ wetted with sample buffer, of an AssayChip™ after exposure to an analyte-containing sample, and of an AssayChip™ after exposure to a biotin-labeled secondary antibody. Each of these images could be subtracted from the final image to obtain signals corrected for various potential artifacts. For example, subtraction of the image obtained after analyte binding could be used to correct for the presence of endogenous bioluminescence in the target analyte. Each such embodiment is included in the scope of the present invention.

In another preferred embodiment, a reverse hybridization method of analysis could be used. This embodiment is particularly preferred for nucleic acid hybridization to complementary nucleic acid probes. In the reverse hybridization method, oligonucleotide probes are attached to an AssayChip™, complementary target nucleic acids and fluorescent probes are added and an image is obtained. The bound complementary target nucleic acids are removed, for example by heating or pH change, and another image is obtained. The second image is subtracted from the first image to determine the corrected luminosity attributable to hybridized target nucleic acids.

These methods of analysis can be used with a CMOS imager or any digital imaging method where pixel images are stored in memory for subsequent processing. The signal obtained will contain much more useful information and will be more intense if the disclosed subtraction method is used, compared to standard techniques utilizing filters. Another advantage is that the scatter effect is used to increase the sensitivity of detecting analyte binding, rather than being discarded or filtered out. Moreover, using the disclosed method it is not necessary that the fluorophore emission and absorption curves be well separated. This increases the range of fluorophores available for use. The full intensity of emission signals can be obtained in the absence of filters, increasing the sensitivity of detection.

The disclosed subtraction methods also eliminate artifacts and defects that have nothing to do with the reaction of interest. For example, small pits on the glass surface or changes in glass thickness or even inherent fluorescence are eliminated. The non-reactive spots completely blank out and do not appear as a signal. Because filters are no longer required, much more light is processed, resulting in greater sensitivity.

Because CMOS imagers and pixel capturing devices in general exhibit random very low level noise, there are limits as to what kinds of signals can be detected. At any given moment, the baseline reference on a CMOS imager may exhibit a random number of spikes. A weak signal falling between two spikes would not normally be detected against this background noise. The signal to noise ratio can be improved if numerous images are captured and added one upon the other. Because the random spikes inherent in a detector such as a CMOS imager are constantly shifting about, by adding one frame upon a second frame upon another frame and so on, the effect on imaging is to average out the random noise. In preferred embodiments, the data used for image analysis and subtraction may represent an average of a number of sequential images taken under identical conditions but at different times. In more preferred embodiments, the averages may represent data from between five and ten sequential images. Using image averaging, weak signals from the emission of an excited fluorophore do not change in sequential images. Thus, the true signals accumulate, while background signals are averaged out.

Method of Analysis

The AssayChip™ or equivalent glass slide, waveguide and/or chip is secured on a stage with a fluidic cube attached to the surface of the glass. A diode laser is used to energize the surface of the glass using the slide as a waveguide. The laser strikes the end of the glass slide at an inclined angle, typically in the range of 30 to 40 degrees. A CMOS imager is used to capture the signal. The CMOS is located beneath the glass slide and is aligned so that spots on the slide are directly above the imager and are sharply focused on the imager surface using appropriate optical lens and apertures.

A number of pictures are taken. Each picture represents a single frame. For example 10 frames each with a 50 ms exposure are taken. These parameters are selected so that the amount of light captured in a single frame is within the sensitive range for the camera, being neither overly bright nor so low as to require too many frames before an image can be observed. The 10 digital frames are then added to set a reference that will be used in subtracting away unwanted signals. This image is referred to as the calibration slide.

The fluidic cube is used to complete all the reactions for detecting a particular pathogen, ending with the avidin-fluorophore and final wash and leaving bound fluorophore where a binding reaction has occurred. The same number of frames with the same exposure time for each frame is taken in processing the sample signal. The luminescent signal for each spot is then determined by subtracting the reference slide from the sample slide. This method removes artifacts on the surface of a glass slide and non-reactive spots leaving only those signals where reactions have occurred binding.

All of the COMPOSITIONS, METHODS and APPARATUS disclosed and claimed herein can be made and executed without undue experimentation in light of the present disclosure. While the compositions and methods of this invention have been described in terms of preferred embodiments, it will be apparent to those of skill in the art that variations may be applied to the COMPOSITIONS, METHODS and APPARATUS and in the steps or in the sequence of steps of the methods described herein without departing from the concept, spirit and scope of the invention. More specifically, it will be apparent that certain agents that are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A method comprising marking an item with a fluorescent binary code.

2. The method of claim 1, wherein the item is a glass slide, waveguide, chip, protein chip, nucleic acid chip, DNA chip or antibody array.

3. The method of claim 1, wherein the binary code identifies the lot number of the item.

4. The method of claim 1, wherein the binary code identifies the manufacturing date of the item.

5. The method of claim 1, wherein the binary code comprises two rows of spots.

6. The method of claim 1, wherein the first row of spots comprises double spots and the second row of spots comprises single spots.

7. The method of claim 6, wherein the binary code is arranged as disclosed in FIG. 3.

8. The method of claim 5, wherein the two rows of spots further comprise a binary 0 reference spot, a binary 1 reference spot, and an ID reference index spot for the binary code.

9. The method of claim 8, wherein the two rows of spots further comprise an ID check sum validation spot.

10. The method of claim 9, wherein the two rows of spots further comprise fourteen code spots.

11. An item marked by the method of claim 1.

12. A method comprising
a) obtaining a first digital image of one or more spots;
b) obtaining a second digital image of the same one or more spots; and
c) subtracting one image from the other image.

13. The method of claim 12, further comprising analyzing the subtracted data to determine the amount of analyte bound to each spot.

14. The method of claim 12, further comprising averaging two or more pictures to obtain each image.

15. The method of claim 14, further comprising averaging five pictures to obtain each image.

16. The method of claim 12, wherein the images are obtained from an array of binding moieties exposed to excitatory light.

17. The method of claim 16, wherein the light from the array is not filtered.

18. The method of claim 17, wherein the array in the first image comprises primary antibodies and the first image is subtracted from the second image.

19. The method of claim 18, wherein the array in the second image comprises primary antibodies, analytes, biotinylated secondary antibodies and streptavidin conjugated fluorophores.

20. The method of claim 17, wherein the second image is subtracted from the first image and the array in the first image comprises nucleic acid probes, target nucleic acids and fluorophores.

21. The method of claim 20, wherein the array in the second image comprises nucleic acid probes.

22. The method of claim 21, further comprising washing the array to remove target nucleic acids after the first image is obtained.
